(19) United States
(12) Patent Application Publication
(10) Pub. No.: US 2024/0044353 A1
(43) Pub. Date: Feb. 8, 2024

(54) Serviceable Edgefold System

(71) Applicant: Illinois Tool Works Inc., Glenview, IL (US)

(72) Inventor: Joel R. Lee, Peotone, IL (US)

(21) Appl. No.: 18/224,544

(22) Filed: Jul. 20, 2023

Related U.S. Application Data
(60) Provisional application No. 63/394,331, filed on Aug. 2, 2022.

(51) Int. Cl. F16B 21/08; F16B 2/22

(52) U.S. Cl. CPC F16B 21/084; F16B 2/22

(57) ABSTRACT

Described is a fastener assembly configured to fasten a soft component to a rigid component. The fastener assembly having a pin, a retainer, and a cap. The cap is coupled to the retainer via a strap and alternates between an open position and a closed position to secure the soft component. The retainer has a body portion, a base portion, and a fastener to engage the component opening. The retainer defines a passageway to receive the shank and the fastener receives a distal end of the shank. The cap defines an opening to receive and engage at least a portion of the body portion in the closed position.

### RELATED APPLICATION

The present application claims priority to U.S. Provisional Patent Application No. 63/394,331, filed Aug. 2, 2022, which is hereby incorporated by reference in its entirety.

### BACKGROUND

Fasteners may be used to secure components together. In some examples, a fastener can be used to secure dissimilar materials, such as a soft object (e.g., cloth, foam, fabric, etc.) to a rigid object (e.g., metal, plastic, wood, etc.). Fasteners can be manufactured as a single-component fastener (e.g., individual nuts, bolts, anchors, and rivets) or as a multi-component fastener. When a multi-component fastener is provided in a loose configuration, the components can become lost or misplaced if the components become separated from one another.

Therefore, a multi-component fastener can be provided where the various components are affixed or tethered to one another. Commonly owned U.S. Patent Pub. No. 2020/0224697, for example, describes a tree fastener assembly having a cap, a body, and a strap that connects the cap with the body. While existing tethered multi-component fastener mitigate the risk of component loss during assembly, they can be more difficult to service and reuse without damage or affecting performance of the assembly fastener.

In light of the above, a need exists for a fastener assembly where various components of the fastener assembly are affixed or tethered to one another and a fastener assembly can be serviced or reused while preserving performance of the fastener assembly.

### SUMMARY

The present disclosure relates generally to an improved fastener, substantially as illustrated by and described in connection with at least one of the figures, as set forth more completely in the claims. More specifically, the present disclosure relates to a fastener assembly for fastening a soft object to the rigid object.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a front perspective view of an example fastener assembly in accordance with an aspect of the present disclosure.

FIG. 1b illustrates a first side elevation view of the example fastener assembly.

FIG. 1c illustrates a second side elevation view of the example fastener assembly.

FIG. 1d illustrates a cross-sectional view of the example fastener assembly taken along cut-line A-A (FIG. 1e).

FIG. 1e illustrates a top plan view of the example fastener assembly.

FIG. 1f illustrates a bottom plan view of the example fastener assembly.

FIG. 1g illustrates a front elevation view of the example fastener assembly.

FIG. 1h illustrates a rear elevation view of the example fastener assembly.

FIG. 1i illustrates an example assembly process for the example fastener assembly.

FIG. 2a illustrates a front perspective view of an example fastener assembly in accordance with another aspect of the present disclosure.

FIG. 2b illustrates a first side elevation view of the example fastener assembly.

FIG. 2c illustrates a second side elevation view of the example fastener assembly.

FIG. 2d illustrates a cross-sectional view of the example fastener assembly taken along cut-line B-B (FIG. 2e).

FIG. 2e illustrates a top plan view of the example fastener assembly.

FIG. 2f illustrates a bottom plan view of the example fastener assembly.

FIG. 2g illustrates a front elevation view of the example fastener assembly.

FIG. 2h illustrates a rear elevation view of the example fastener assembly.

FIG. 2i illustrates an example assembly process for the example fastener assembly.

FIG. 3a illustrates a front perspective view of yet an example fastener assembly in accordance with yet another aspect of the present disclosure.

FIG. 3b illustrates a side elevation view of the example fastener assembly.

FIG. 3c illustrates a cross-sectional view of the example fastener assembly taken along cut-line C-C (FIG. 3a).

FIGS. 4a through 4f illustrate additional fastener styles suitable for coupling the retainer with the component in accordance with other aspects of this disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “coupled,” “coupled to,” and “coupled with” as used herein, each mean a relationship between or among two or more devices, apparatuses, elements, functions, operations, processes, components, systems, subsystems, and/or means, constituting any one or more of: (i) a connection, whether direct or through one or more other devices, apparatuses, files, elements, functions, operations, processes, components, systems, subsystems, or means; and/or (ii) a functional relationship in which the operation of any one or more devices, apparatuses, elements, functions, operations, processes, components, systems, subsystems, or means depends, in whole or in part, on the operation of any one or more others thereof.

Fasteners vary in size and shape. In some cases, fasteners can be the same shape, but will vary in size. While fasteners are most often associated with creating non-permanent joints. They are also employed in numerous other functions that may require a more permanent fixture. Therefore, the following disclosure should not be limited to fasteners used in non-permanent joints, but rather would be applicable to fastener used in any situation to couple two or more objects.

In one example, a fastener assembly for attaching a rigid component having a component opening relative to a soft component having an aperture comprises: a pin having a head and a shank; a retainer having a body portion, a base portion, and a fastener configured to engage the component opening, and a cap coupled to the retainer via a strap and configured to alternate between an open position and a closed position to secure the soft component. The retainer can define a passageway configured to receive the shank. The fastener can be positioned at or adjacent the passageway and configured to receive a distal end of the shank. The cap can defines an opening configured to receive and engage at least a portion of the body portion in the closed position.

In another example, a fastener assembly for attaching a rigid component having a component opening relative to a soft component having an aperture comprises: a retainer having a body portion, a base portion, and a fastener configured to engage the component opening, wherein the retainer defines a passageway configured to receive a shank of a pin, and wherein the fastener is positioned at or adjacent the passageway and configured to receive a distal end of the shank; and a cap coupled to the retainer via a strap and configured to alternate between an open position and a closed position to secure the soft component, wherein the cap defines an opening configured to receive and engage at least a portion of the body portion in the closed position.

In yet another example, a fastener assembly for attaching a rigid component having a component opening relative to a soft component having an aperture comprises: a retainer having a body portion, a clip, and a fastener, wherein the fastener is configured to engage the component opening; and a cap coupled to the retainer via a strap and configured to alternate between an open position and a closed position to secure the soft component, wherein the cap defines an opening figured to receive and engage the clip in the closed position. In some examples, the clip comprises a pair of wings resiliently coupled to a post. In some examples, the fastener is a push-pin fastener having a plurality of fins arranged along a length of a shank or a W-shaped clip fastener.

In some examples, the body portion includes one or more locking features configured to engage and secure the cap relative to the retainer when positioned in the closed position.

In some examples, the fastener and the base portion are an integrated component.

In some examples, the fastener and the base portion are separate components.

In some examples, the fastener comprises a pair of flexible legs resiliently coupled to the base portion.

In some examples, the pair of flexible legs are configured receive a distal end of the shank between the pair of flexible legs to bias the pair of flexible legs outwardly. Each of the pair of flexible legs can comprise one or more rigid retention features at an outer surface thereof.

In some examples, the body portion comprises a slot formed therein and the pin comprises a tongue extending radially from the shank and configured to engage the slot.

In some examples, the pin is configured to rotate about an axis of rotation within the passageway between a first rotational position and a second rotational position.

In some examples, the shank is configured to bias the pair of flexible legs outwardly in the first rotational position and to not bias the pair of flexible legs outwardly in the second rotational position. The head can be formed to define a knob to enable the pin to be grasped by a user.

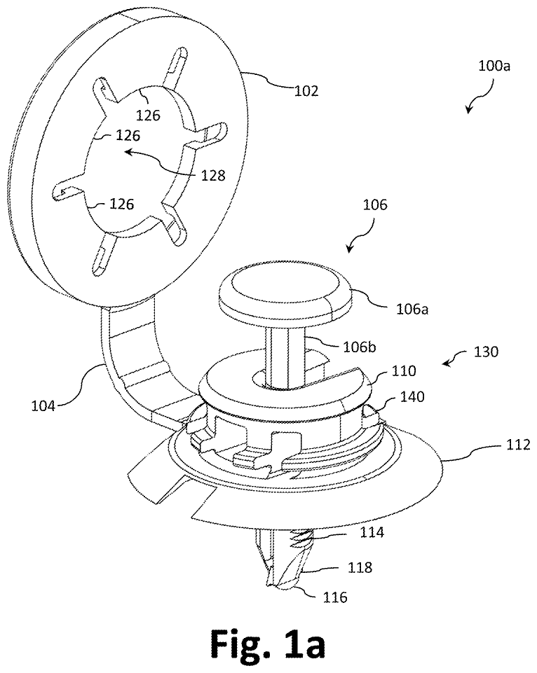

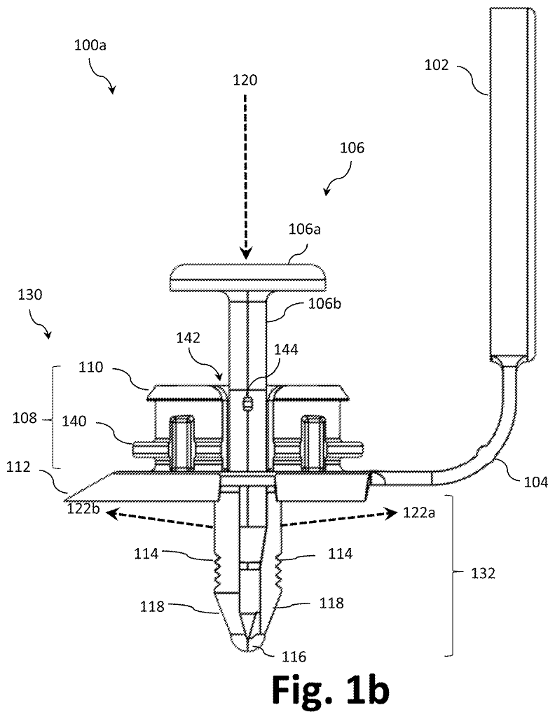

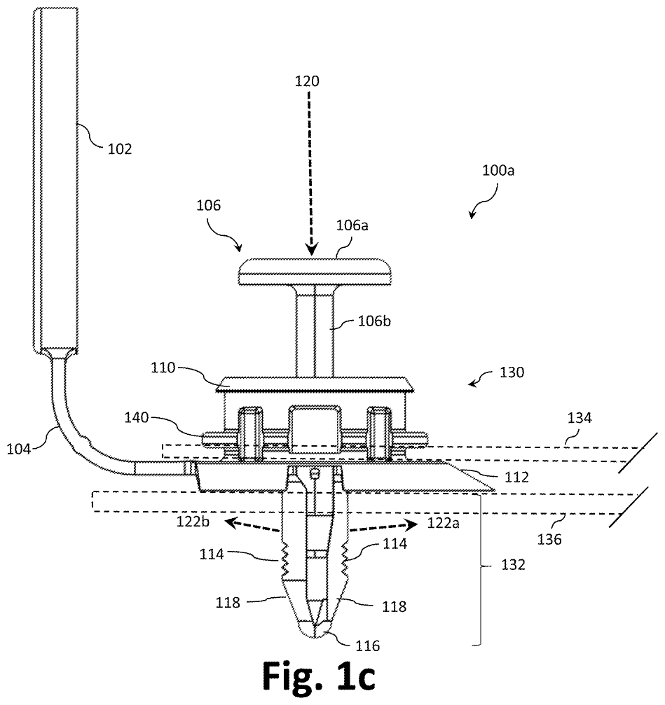

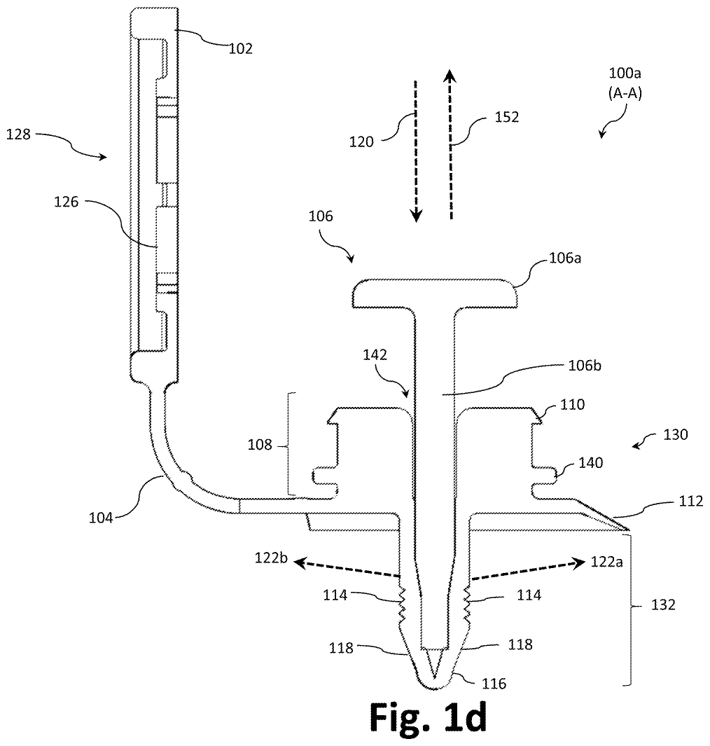

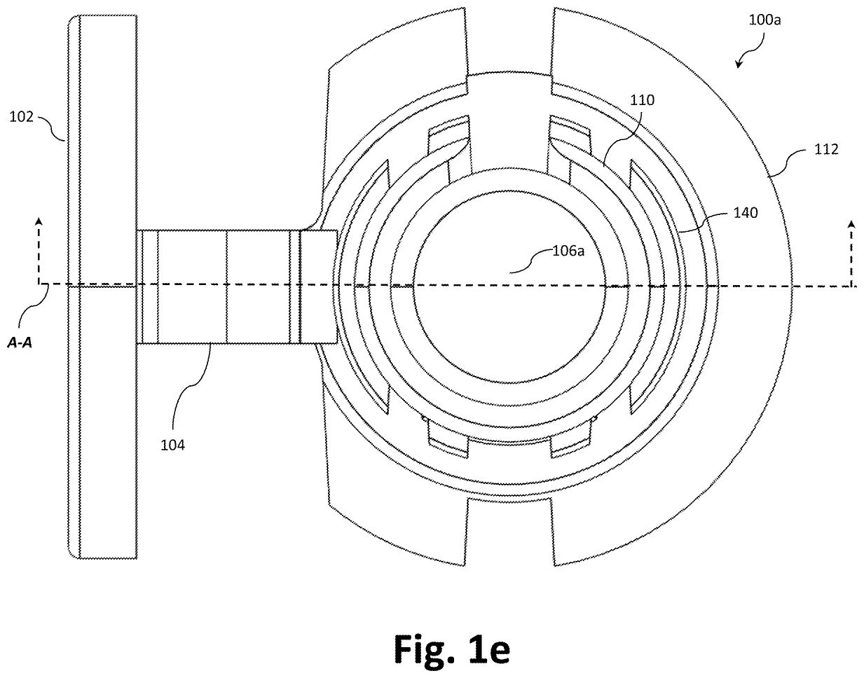

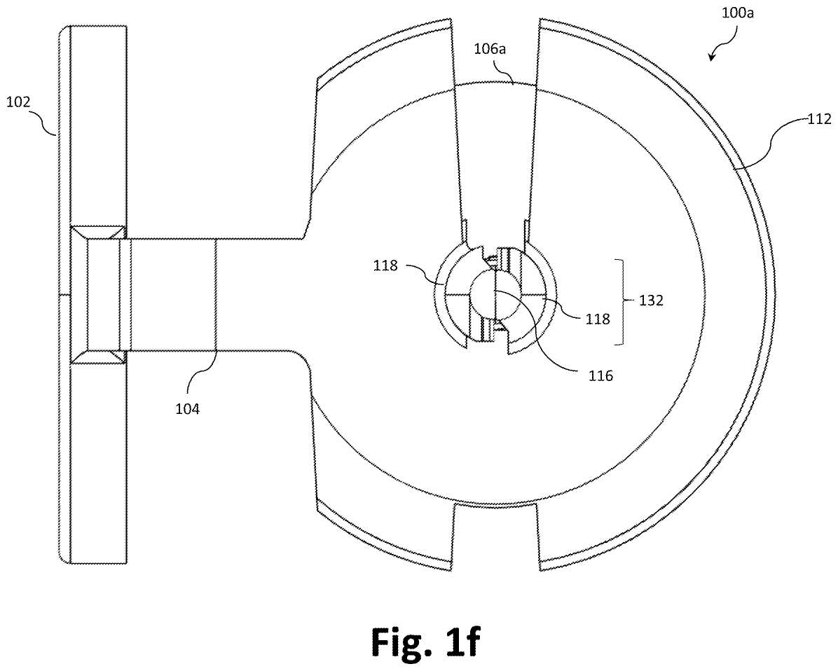

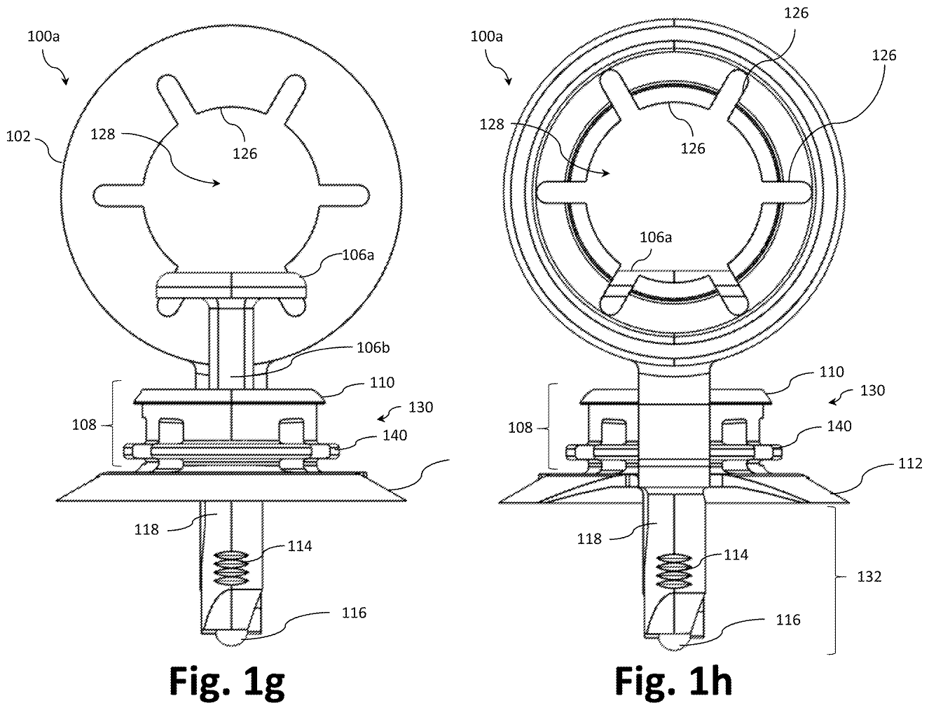

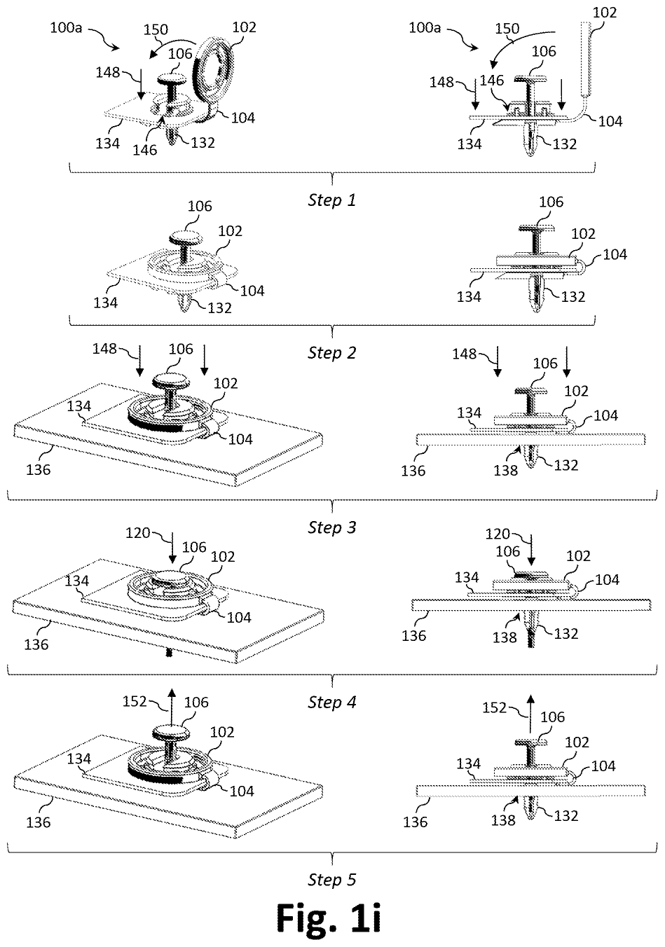

FIG. 1a illustrates a front perspective view of an example fastener assembly 100a in accordance with an aspect of the present disclosure. FIGS. 1b and 1c illustrate, respectively, first and second side elevation view of the example fastener assembly 100a, while FIG. 1d illustrates a cross-sectional view taken along cut-line A-A (FIG. 1e). FIGS. 1e and 1f illustrate, respectively, top and bottom plan views of the example fastener assembly 100a. FIGS. 1g and 1h illustrate, respectively, front and rear elevation views of the example fastener assembly 100a. Finally, FIG. 1i illustrates example assembly and disassembly process for the example fastener assembly 100a. As will be described, the fastener assembly 100a is configured to fasten a soft component 134 relative to a rigid component 136. In some examples, the fastener assembly 100a can be described as an edge-fold system or fastener because, when installed, a portion of the fastener folds over an edge of the soft component 134.

The illustrated fastener assembly 100a is a multi-component fastener where the various components of the fastener assembly are affixed and/or tethered to one another to mitigate component loss during shipment and/or final assembly or installation. As a result, not only is component loss mitigated via the disclosed fastener assembly 100a, but, where desired, the fastener assembly 100a can be shipped (e.g., to a tier customer for installation) in a partially assembled configuration and/or as a part-in-assembly (PIA). In addition, the fastener assembly 100a can be serviced and/or reused, while preserving performance of the fastener assembly 100a and without damaging either of the soft component 134 or the rigid component 136. In other words, the soft component 134 can be attached to the rigid component 136 via the fastener assembly 100a and later removed and then reattached without affecting performance of the fastener assembly 100a or materially damaging the soft component 134 or the rigid component 136.

The soft component 134 can be a flexible and/or pliable sheet of material fabricated from, for example, cloth, foam, fabric, leather etc. The soft component 134 may be, for example, an automotive covering, vapor seal, sheet, etc. While the fastener assembly 100a will be described primarily as a fastener assembly configured to attach a soft component 134 to a rigid component 136, the fastener assembly 100a can be used to attach other thin or sheet-like materials, objects, and/or components.

Depending on the application, the rigid component 136 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. The rigid component 136 may include, define, or otherwise provide a component opening 138 (e.g., a hole, aperture, etc.), which may be formed during manufacturing of the rigid component 136. The rigid component 136 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like.

As illustrated, the fastener assembly 100a generally comprises a retainer 130, a pin 106, and a cap 102 coupled to the retainer 130 via a strap 104. The fastener assembly 100a and components thereof (e.g., retainer 130, pin 106, cap 102, strap 104 etc.) can be fabricated from a plastic material using a plastic injection technique, additive manufacturing, or otherwise. In some examples, one or more components of the fastener assembly 100a may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. In some examples, two or more components of the fastener assembly 100a can be formed from the same material and/or as a single, integrated component (e.g., a unitary structure). In one example, the retainer 130, the cap 102, and the strap 104 can be fabricated as a unitary structure. In other examples, the retainer 130 and the cap 102 can be fabricated as separate components or structures and later joined via the strap 104 (e.g., via a welding process, adhesive, etc.).

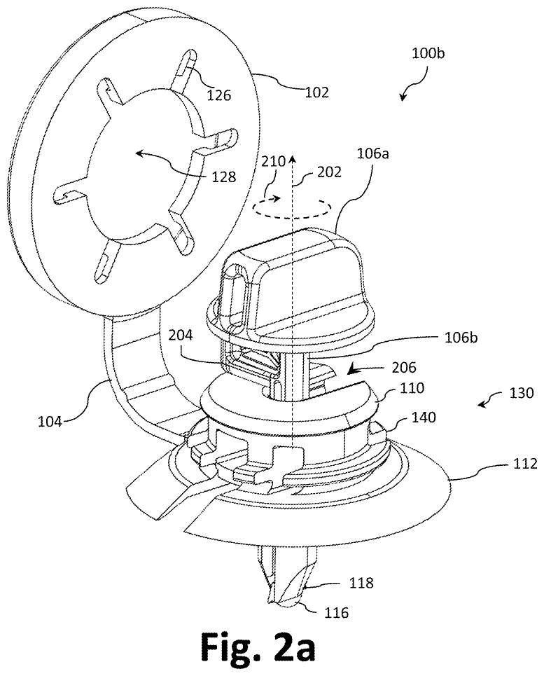

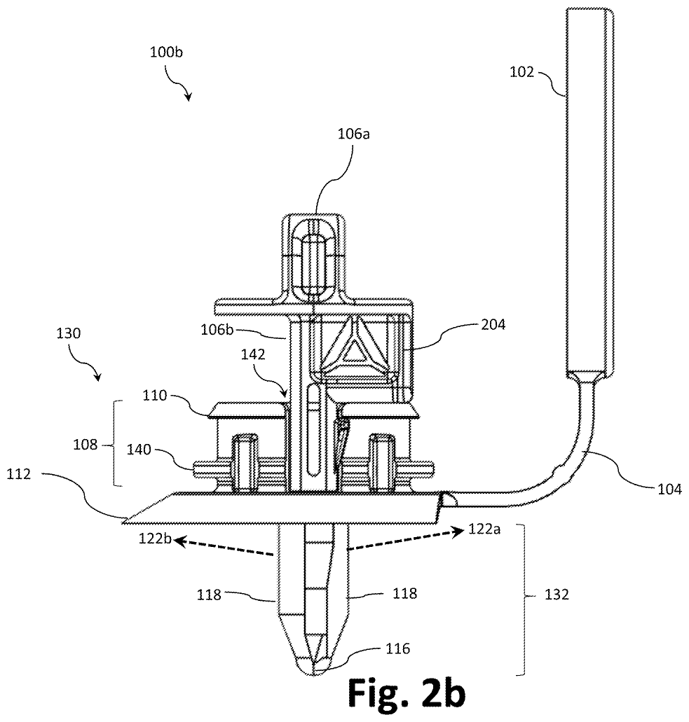

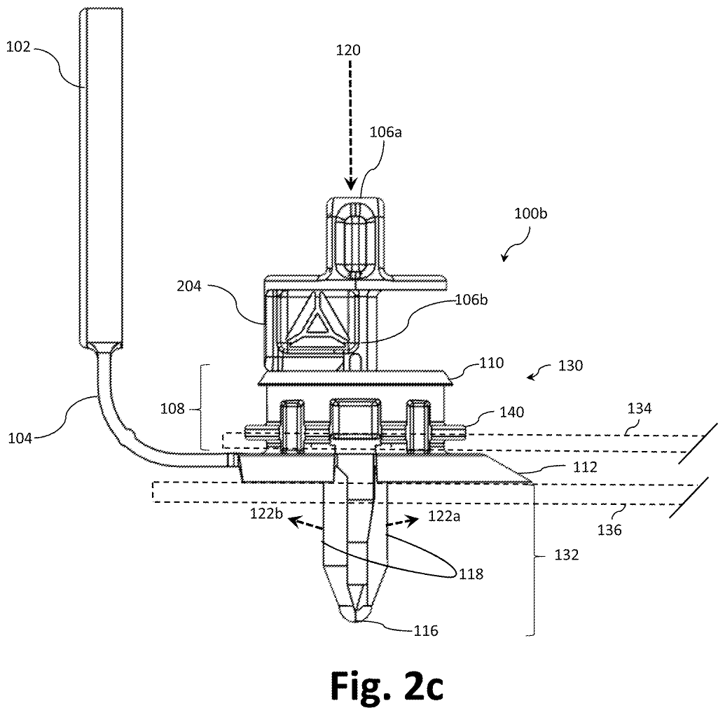

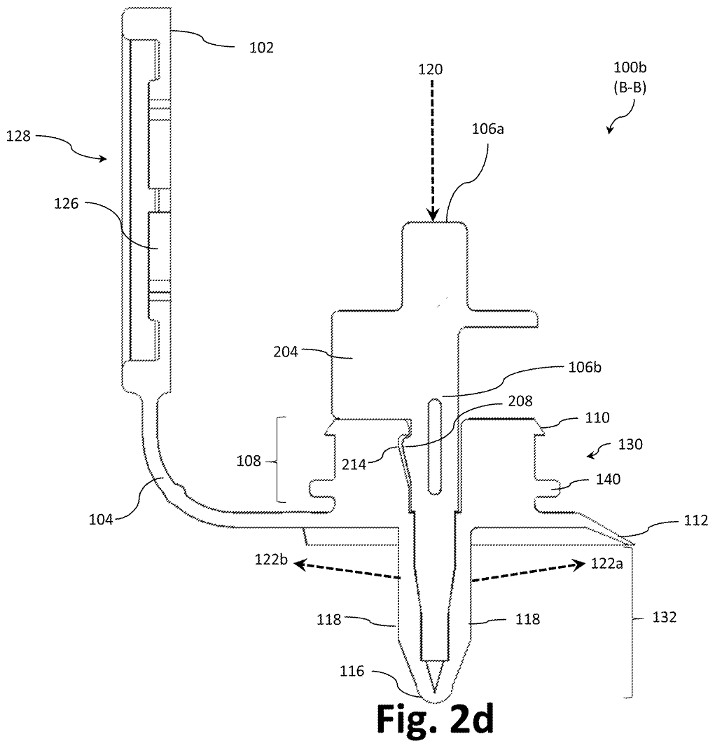

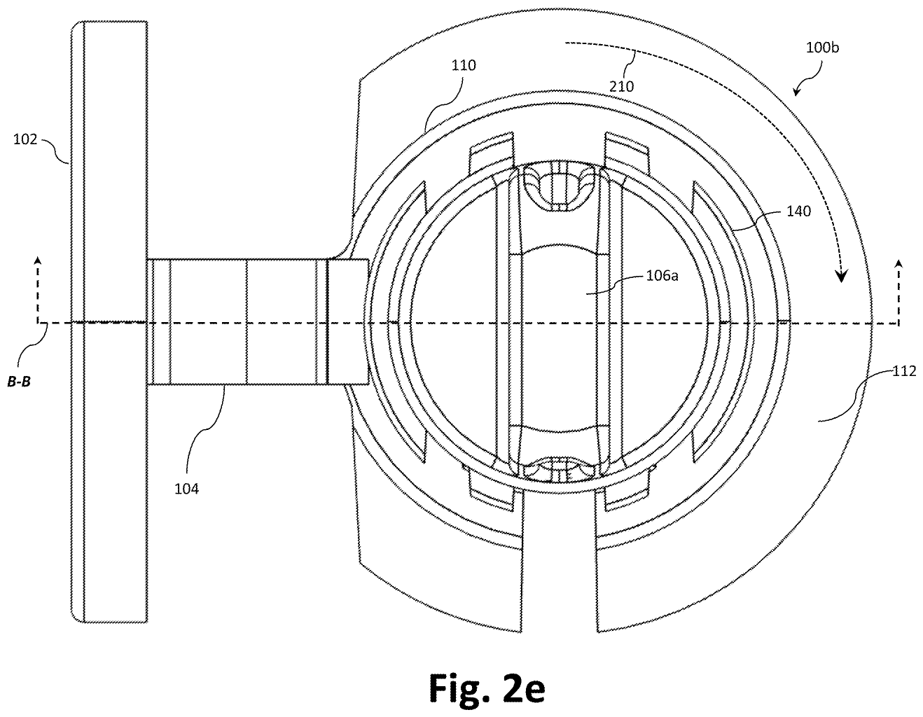

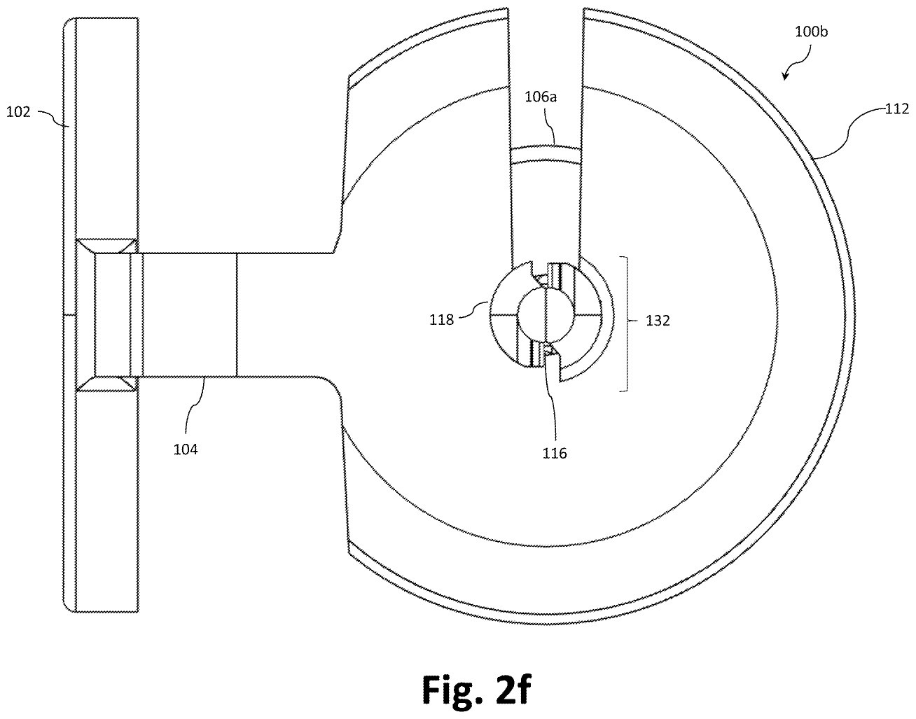

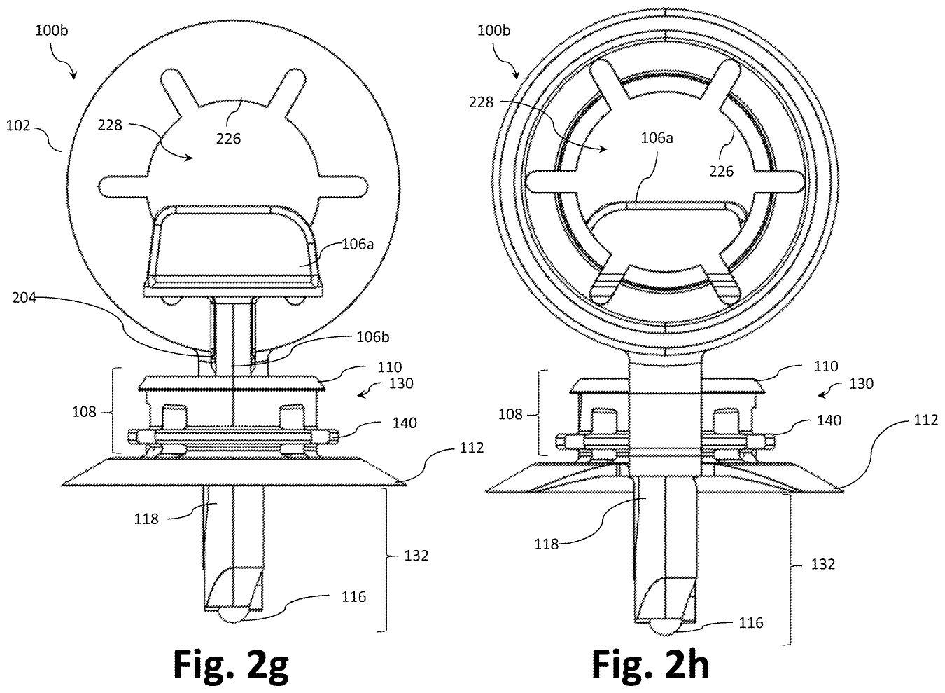

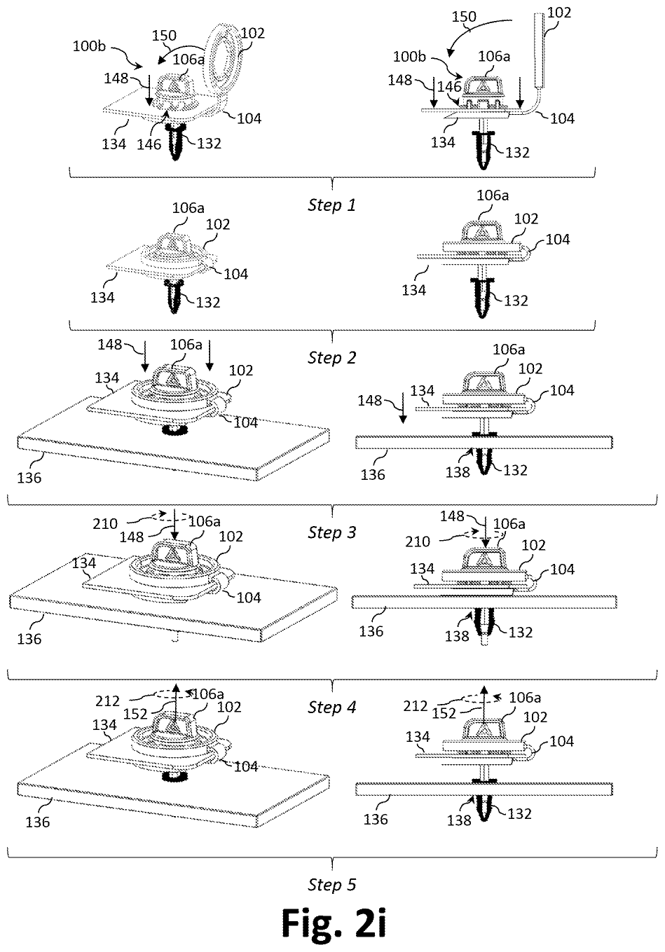

The pin 106 comprises, or defines, a head 106a and a shank 106b extending perpendicularly therefore. The head 106a is illustrated as generally circular plate (e.g., a short cylinder), however other shapes are contemplated (an example of which is illustrated in connection with FIGS. 2a through 2i). The head 106a and a shank 106b can be fabricated as a single component, or as separate components or structures and later joined together. In some examples, the pin 106 may be fabricated from a material that is dissimilar to that of the cap 102, the retainer 130, and/or the strap 104, such as metal, wood, stone, etc.

The cap 102 can be formed with one or more features to engage the retainer 130. For example, the illustrated cap 102 comprises, or defines, an opening 128 and a plurality of tabs 126 at the perimeter thereof and oriented into opening 128. In other words, the cap 102 can be configured as a tab washer to engage the retainer 130 (e.g. via one or more locking features 110). The strap 104 is flexible and joins the cap 102 to the retainer 130, while enabling the cap 102 to alternate between an open position (e.g., a first position) and a closed position (e.g., a second position). In the closed position, the cap 102 can secure the soft component 134.

The retainer 130 comprises, or defines, a body portion 108, a base portion 112, and a fastener 132. The body portion 108 includes a shelf 140 and one or more locking features 110 configured to engage, align, and/or secure the cap 102 relative to the retainer 130 when positioned in the closed position. To that end, the body portion 108 is sized as shaped to pass at least partially through the opening 128 and to engage the cap 102 via the plurality of tabs 126 and/or locking feature 110. In the illustrated example, the body portion 108 is generally cylindrical and the locking feature 110 is provided as an annular ledge formed at the upper end of the body portion 108, while the shelf 140 is an annular lip formed closer to the base portion 112 (the spacing between the shelf 140 and the base portion can be adjusted to accommodate a thickness of a desired soft component 136). In some examples, as illustrated, the locking feature 110 is chamfered to assist in aligning the cap 102 during assembly (e.g., closure thereof). When in the closed position, the cap 102 is secured between the shelf 140 and the locking feature 110. In addition to helping to secure the cap 102 in place (e.g., reducing rattle, movement, etc.), the shelf 140 can also serve as a stop to limit compression by the cap 102 upon the soft component 134, thus mitigating risk of damage or deformation thereto.

The fastener 132 is configured to pass at least partially through the component opening 138 to engage the rigid component 136. In this example, the fastener 132 is illustrated as a pair of flexible legs 118 resiliently coupled to the base portion 112 at their proximal ends (e.g., first ends) and joined to one another at their distal ends (e.g., second ends) via a bridge portion 116. The height of the fastener 132 (e.g., the distance between the bridge portion 116 and the base portion 112) can be selected to accommodate desired rigid components 136 of a given thickness.

Each of the pair of flexible legs 118 may further comprise one or more rigid retention features 114 at the outer surfaces thereof to increase the grip with the rigid component 136 (e.g., to increase friction between the pair of flexible legs 118 and the rigid component 136 at the component opening). The rigid retention features 114 may be provided in the form of, for example, grooves, ridges, abrasive textures, etc.

During assembly, the shank 106b of the pin 106 is urged by a downward force 120 to pass through a passageway 142 formed through the retainer 130 to engage the fastener 132. In this example, a distal end of the shank 106b is inserted between the pair of flexible legs 118 to bias the pair of flexible legs 118 outwardly as indicated by the arrows 122a, 122b. Urging the flexible legs 118 outwardly as indicated by the arrows 122a, 122b provides a resilient connection between the retainer 130 and the rigid component 136 via the fastener 132.

Conversely, removing the distal end of the shank 106b from the passageway 142 by pulling the pin 106 via an upward force 152 allows the pair of flexible legs 118 to return to an unbiased position (e.g., a default position), thus releasing the resilient connection between the retainer 130 and the rigid component 136 to enable removal of the fastener 132 from the component opening 138.

FIG. 1i illustrates example assembly and disassembly process for the example fastener assembly 100a. While the assembly and disassembly process is illustrated as comprising five steps, additional or fewer steps may be employed and/or the two or more of the various steps may be consolidated into one. In this example, the fastener assembly 100a is provided initially with the cap 102 in the open position and with the pin 106 at least partially inserted into the passageway 142. The pin 106 can be secured as partially inserted into the passageway 142 via, for example, a pin retention feature 144, such as bump, let, ridge, or otherwise.

At step 1, an aperture 146 (e.g., a hole) formed in the soft component 134 is passed over the head 106a of the pin 106 and around the body portion 108 of the retainer 130 in the direction indicated by arrows 148. The soft component 134 is passed over the retainer 130 below the locking feature 110 to reside between the locking feature 110 and an upper surface of the base portion 112. An edge of the soft component 134 can be positioned adjacent (e.g., abutting) the strap 104. In some examples, an edge portion of the soft component 134 can be folded upon itself with the aperture 146 passing through both layers to increase strength at the connection point by doubling the thickness. In either case, once the soft component 134 is in position, the cap 102 is pivoted via the strap 104 from the open position to the closed position in the direction indicated by arrow 150.

At step 2, the cap 102 is in the closed position and the cap 102 is secured to the retainer 130 (e.g., via the aforementioned plurality of tabs 126 and/or locking features 110). For example, the cap 102 is lowered toward the body portion 108 such that the plurality of tabs 126 and the locking features 110 engage. As illustrated, the strap 104 extends (e.g., “folds”) around a peripheral edge of the soft component 134 such that the cap 102 is secured to the body portion 108 via the cap 102. In effect, the soft component 134 is sandwiched between the cap 102 and the upper surface of the base portion 112. Where desired, the soft component 134 could be shipped to, for example, a customer with the one or more fastener assemblies 100a pre-installed as a part-in-assemble (PIA) for installation on the rigid component 136.

At step 3, the fastener 132 is passed at least partially through the component opening 138 of the rigid component 136. For example, the fastener 132 can then be inserted and pushed through the component opening 138 in the direction indicated by arrows 148 until an underside surface of the base portion 112 is flush with and/or against the rigid component 136.

At step 4, a downward force 120 is applied to the pin 106. As the pin 106 passes downward and between the flexible legs 118, the pin 106 biases the flexible legs 118 to expand the flexible legs 118 outwardly as indicated by the arrows 122a, 122b. Once the pin 106 is fully seated, the fastener assembly 100a is now secured to the rigid component 136.

At step 5, if desired, the fastener assembly 100a can be removed from the rigid component 136 by applying an upward force 152 is applied to the pin 106 (e.g., pulling the pin 106 via the head 106a) to allow the pair of flexible legs 118 to return to their narrower, unbiased position; thus, releasing the connection between the retainer 130 and the rigid component 136 to enable removal of the fastener 132 from the component opening 138. Notably, the linear removal of the pin 106 and fastener 132 (e.g., without any rotation or screwing motion) avoids damage to the fastener assembly 100, thus enabled reuse of the fastener assembly 100a.

FIG. 2a illustrates a front perspective view of an example fastener assembly 100b in accordance with another aspect of the present disclosure. FIGS. 2b and 2c illustrate, respectively, first and second side elevation view of the example fastener assembly 100b, while FIG. 2d illustrates a cross-sectional view taken along cut-line B-B (FIG. 2e). FIGS. 2e and 2f illustrate, respectively, top and bottom plan views of the example fastener assembly 100b. FIGS. 2g and 2h illustrate, respectively, front and rear elevation views of the example fastener assembly 100b. Finally, FIG. 2i illustrates an example assembly process for the example fastener assembly 100b.

The fastener assembly 100b of FIGS. 2a through 2i is substantially the same as the fastener assembly 100a of FIGS. 1a through 1i except that the fastener assembly 100b employs a pin 106 with quarter-turn functionality. While the fastener assembly 100a of FIGS. 1a through 1i employs a pin 106 that is inserted and removed solely through a linear motion, it may desirable in some cases to introduce a rotational movement about an axis of rotation 202 to mitigate any risk of inadvertent pullout of the pin 106. For example, in environments where a fastener assembly is exposed to significant vibration, the pin 106 could, over time, dislodge from the fastener portion 132, thus weakening the connection.

In this example, the pin 106 comprises, or defines, a head 106a, a shank 106b extending perpendicularly from the head 106a, and one or more additional features (e.g., a tongue 204 and/or a projection 208) extending radially from the shank 106b and away from the axis of rotation 202. Unlike the pin 106 described in connection with the fastener assembly 100a of FIGS. 1a through 1i, the illustrated head 106a is formed to define a knob that can be grasped and turned with the hand of an operator. The head 106a can be designed to be easily gripped and turned, allowing an installer to control and adjust the pin 106. For example, in operation, the head 106a is shaped to enable the pin 106 to rotate about the axis of rotation 202 within the passageway 142 between a first rotational position and a second rotational position. The head 106a, shank 106b, tongue 204, and/or the projection 208 can be fabricated as a single component, or as separate structures and later joined together. In other examples, the head 106a can be shaped for engagement with a tool. For example, the head 106a can be hex-shaped or otherwise shaped to engage a socket wrench, screw driver, etc.

In the illustrated example, and with reference to FIG. 2d, the tongue 204 and the projection 208 are positioned on the same side of the shank 106b such that they are vertically aligned. The retainer 130 can further define a pocket 214 sized and shaped to receive the projection 208 when the pin 106 is positioned in the second rotational position. As illustrated, the body portion 108 can define the pocket 214. The pocket 214 and the projection 208 interface one another to mitigate unwanted pullout of the pin 106 from the passageway 142.

Once rotated about the axis of rotation 202 from the first rotational position in the direction indicated by the first rotational force 210 to the second rotational position, the tongue 204 aligns with the slot 206. Once aligned, a downward force 120 is applied to the pin 106. In response to the downward force 120, the tongue 204 slides into and engages a slot 206 formed in or on the body portion 108 through, for example, an interference fit. Additionally or alternatively, one or both of the tongue 204 and/or the slot 206 may include one or more features to engage one another, such as bumps, detents, etc.

In response to the downward force 120, the projection 208 passes through passageway 142 to engage one or both of the pair of flexible legs 118. The projection 208 biases one or both of the pair of flexible legs 118 outwardly. While a single projection 208 is visible in FIG. 2d, additional projections 208 can be provided. For example, a projection x24 may be provided for each of the pair of flexible legs 118. In one example, two projections x24 are provided and positioned on opposed surfaces of the shank 106b.

Additionally or alternatively, a portion of the shank 106b can be shaped such that, during linear insertion and prior to rotation, the shank 106b can be more easily inserted between the pair of flexible legs 118 and, when rotated (e.g., by 90 degrees about an axis of rotation 202), the shank 106b biases the pair of flexible legs 118 outwardly. For example, the shank 106b can have a portion with a cross-section that is oval, where the narrow diameter of the oval releases (i.e., does not bias) the pair of flexible legs 118 in the first rotational position and the wider diameter of the oval biases the pair of flexible legs 118 outwardly in the second rotational position. In some examples, the fastener 132 can be provided as a component that is separate from the retainer 130.

FIG. 2i illustrates example assembly and disassembly process for the example fastener assembly 100b. While the assembly and disassembly process is illustrated as comprising five steps, additional or fewer steps may be employed and/or the two or more of the various steps may be consolidated into one step. In this example, the fastener assembly 100b is provided initially with the cap 102 in the open position and with the pin 106 at least partially inserted into the passageway 142.

At step 1, an aperture 146 (e.g., a hole) formed in the soft component 134 is passed over the head 106a of the pin 106 and around the body portion 108 of the retainer 130 in the direction indicated by arrows 148. The soft component 134 is passed over the retainer 130 below the locking feature 110 to reside between the locking feature 110 and an upper surface of the base portion 112. An edge of the soft component 134 can be positioned adjacent (e.g., abutting) the strap 104. In some examples, an edge portion of the soft component 134 can be folded upon itself with the aperture 146 passing through both layers to increase strength at the connection point by doubling the thickness. In either case, once the soft component 134 is in position, the cap 102 is pivoted via the strap 104 from the open position to the closed position in the direction indicated by arrow 150.

At step 2, the cap 102 is in the closed position and the cap 102 is secured to the retainer 130 (e.g., via the aforementioned plurality of tabs 126 and/or locking features 110). For example, the cap 102 is lowered toward the body portion 108 such that the plurality of tabs 126 and the locking features 110 engage. As illustrated, the strap 104 extends (e.g., “folds”) around a peripheral edge of the soft component 134 such that the cap 102 is secured to the body portion 108 via the cap 102. In effect, the soft component 134 is sandwiched between the cap 102 and the upper surface of the base portion 112. Where desired, the soft component 134 could be shipped to, for example, a customer with the one or more fastener assemblies 100b pre-installed as a part-in-assemble (PIA) for installation on the rigid component 136.

At step 3, the fastener 132 is passed at least partially through the component opening 138 of the rigid component 136. For example, the fastener 132 can then be inserted and pushed through the component opening 138 in the direction indicated by arrows 148 until an underside surface of the base portion 112 is flush with and/or against the rigid component 136.

At step 4, a first rotational force 210 to align the tongue 204 with the slot 206; followed by a downward force 120 is applied to the pin 106. As the pin 106 passes downward and between the flexible legs 118, the pin 106 biases the flexible legs 118 to expand the flexible legs 118 outwardly as indicated by the arrows 122a, 122b. Once the pin 106 is fully seated, the fastener assembly 100b is now secured to the rigid component 136.

At step 5, if desired, the fastener assembly 100b can be removed from the rigid component 136 by applying as second rotational force 212 (that is opposite the direction of the first rotational force 210) followed by an upward force 152 is applied to the pin 106 (e.g., pulling the pin 106 via the head 106a) to allow the pair of flexible legs 118 to return to the unbiased position, thus releasing the connection between the retainer 130 and the rigid component 136 to enable removal of the fastener 132 from the component opening 138.

A person of skill in the art would understand that the pin 106 can be configured to rotate in either direction. More specifically, once the pin's 206 tongue 204 has rotated a predetermined distance over the retainer 130, the pin 106 can be lowered into the retainer 130 to bias the flexible legs 118 outwardly.

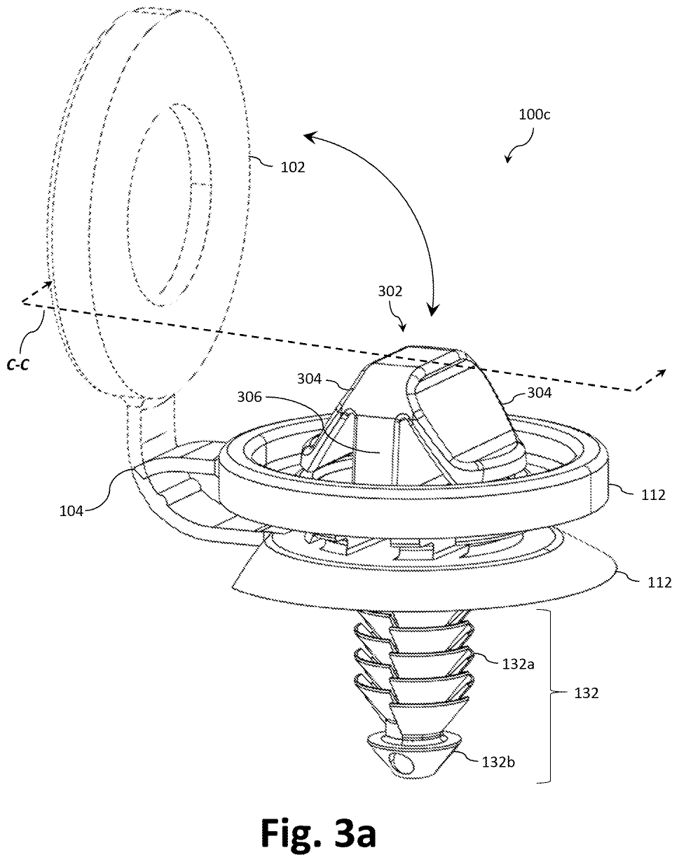

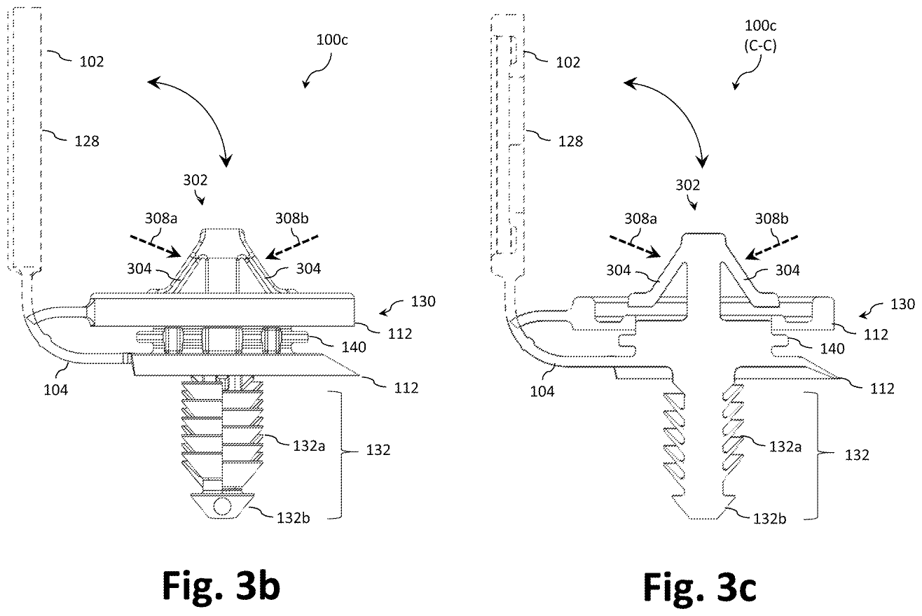

FIG. 3a illustrates a front perspective view of an example fastener assembly 100c in accordance with yet another aspect of the present disclosure. FIG. 3b illustrates a side elevation view of the example fastener assembly 100c, while FIG. 3c illustrates a cross-sectional view taken along cut-line C-C (FIG. 3a). The examples described in connection with FIGS. 1a through 1i and FIGS. 2a through 2i each describe a pin 106 that is urged by a downward force 120 to pass through a passageway 142 formed through the retainer 130 to engage the fastener 132; however, in some examples, a different form of fastener 132 may be desired.

In this example, rather than a pair of flexible legs 118 that are biased outwardly by a portion of the shank 106b, the fastener 132 could be configured as a push-pin fastener (sometimes called trees, pine trees, Christmas trees, etc.). In this example, the fastener 132 includes a plurality of fins 132a arranged along a length of a shank 132b that are resiliently connected to the shank 132b and configured to deflect as the fastener 132 is passed through a component opening 138 formed in the component 136. The fins 132a may be shaped as blades, teeth, barbs, or the like. As illustrated, the fins 132a are angled away from a central longitudinal axis of the shank 132b and are configured to deflect inward toward the central longitudinal axis as the fastener 132 is passed through the component opening 138 in the component 136. The fins 132a are angled upwardly relative to the central longitudinal axis (forming an acute angle between each fin 132a and the central longitudinal axis of the shank) to resist pullout forces.

In addition to or in lieu of the aforementioned locking feature 110, the retainer 130 can comprises a clip 302 configured to engage the cap 102. In the illustrated example, the clip 302 includes a pair of wings 304 resiliently coupled to a post 306. The post 306 extends away (e.g., upwardly) from the retainer 130 at, for example, a right angle. When the cap 102 is pivoted to assume the closed configuration, the clip 302 passes at least partially through the opening 128 to engage the cap 102 (e.g., at the perimeter of the opening 128), thus causing the pair of wings 304 to flex inwardly as indicated by arrows 308a, 308b until the cap 102 passes the distal ends of each wing 304 to become snapped in place and/or against the shelf 140. To return the cap 102 to the open position (e.g., to remove the soft component 134), a user can pinch the clip 302 to compress the pair of wings 304 such that they again flex inwardly as indicated by arrows 308a, 308 thus releasing and allowing the cap 102 to pivot via the strap 104 to the open position.

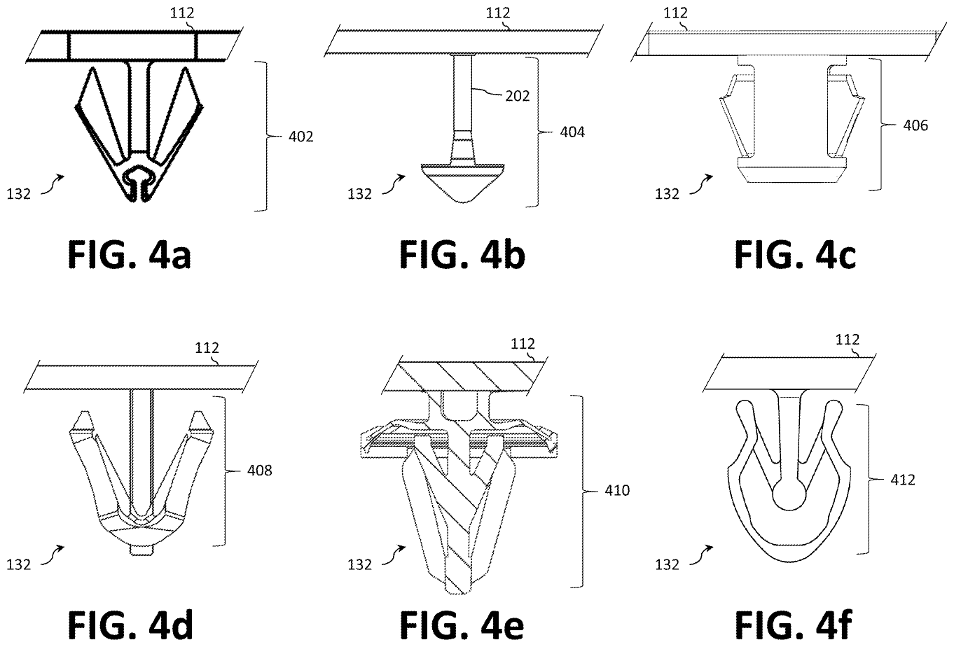

While the fastener 132 is illustrated in FIG. 3a through 3c as a push-pin fastener, other fastener designs are contemplated. For example, FIGS. 4a through 4f illustrate additional fastener styles that can be used. Specifically, FIGS. 4a through 4f illustrate, respectively, a W-shaped clip fastener 402 (illustrated as a 2-legged clip fastener), pin fastener 404, a box-prong fastener 406 (illustrated as a 2-legged box-prong fastener), a specialty clip assembly 408 (e.g., a CenterLok™ fastener, which is available from Deltar®), a clip assembly with four retaining legs 410, and an clip assembly with two snap-engaging seats 412. The clip assembly with four retaining legs 410, which is illustrated in FIG. 4e as a cross sectional view, is further described in connection with commonly-owned U.S. Pat. No. 10,385,901 to Jeffrey J. Steltz. The clip assembly with two snap-engaging seats 412 of FIG. 4f is further described in connection with commonly-owned U.S. Pat. No. 10,018,214 to Fulvio Pacifico Yon.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A fastener assembly for attaching a rigid component having a component opening relative to a soft component having an aperture, the fastener assembly comprising:
a pin having a head and a shank;
a retainer having a body portion, a base portion, and a fastener configured to engage the component opening,
wherein the retainer defines a passageway configured to receive the shank, and
wherein the fastener is positioned at or adjacent the passageway and configured to receive a distal end of the shank; and
a cap coupled to the retainer via a strap and configured to alternate between an open position and a closed position to secure the soft component,
wherein the cap defines an opening configured to receive and engage at least a portion of the body portion in the closed position.

2. The fastener assembly of claim 1, wherein the body portion includes one or more locking features configured to engage and secure the cap relative to the retainer when positioned in the closed position.

3. The fastener assembly of claim 1, wherein the fastener and the base portion are an integrated component.

4. The fastener assembly of claim 1, wherein the fastener and the base portion are separate components.

5. The fastener assembly of claim 1, wherein the fastener comprises a pair of flexible legs resiliently coupled to the base portion.

6. The fastener assembly of claim 5, wherein the pair of flexible legs are configured receive a distal end of the shank between the pair of flexible legs to bias the pair of flexible legs outwardly.

7. The fastener assembly of claim 5, wherein each of the pair of flexible legs comprises one or more rigid retention features at an outer surface thereof. therein.

8. The fastener assembly of claim 1, wherein the body portion comprises a slot formed

9. The fastener assembly of claim 8, wherein the pin comprises a tongue extending radially from the shank and configured to engage the slot.

10. The fastener assembly of claim 5, wherein the pin is configured to rotate about an axis of rotation within the passageway between a first rotational position and a second rotational position.

11. The fastener assembly of claim 10, wherein the shank is shaped at a distal end thereof and to configure to bias the pair of flexible legs outwardly in the first rotational position and to not bias the pair of flexible legs outwardly in the second rotational position.

12. The fastener assembly of claim 10, wherein the head is formed to define a knob to enable the pin to be grasped by a user.

13. A fastener assembly for attaching a rigid component having a component opening relative to a soft component having an aperture, the fastener assembly comprising:
a retainer having a body portion, a clip, and a fastener,
wherein the fastener is configured to engage the component opening; and
a cap coupled to the retainer via a strap and configured to alternate between an open position and a closed position to secure the soft component,
wherein the cap defines an opening figured to receive and engage the clip in the closed position.

14. The fastener assembly of claim 13, wherein the clip comprises a pair of wings resiliently coupled to a post.

15. The fastener assembly of claim 13, wherein the fastener is a push-pin fastener having a plurality of fins arranged along a length of a shank.

16. The fastener assembly of claim 13, wherein the fastener is a W-shaped clip fastener.

17. A fastener assembly for attaching a rigid component having a component opening relative to a soft component having an aperture, the fastener assembly comprising:
a retainer having a body portion, a base portion, and a fastener configured to engage the component opening,
wherein the retainer defines a passageway configured to receive a shank of a pin, and
wherein the fastener is positioned at or adjacent the passageway and configured to receive a distal end of the shank; and
a cap coupled to the retainer via a strap and configured to alternate between an open position and a closed position to secure the soft component,
wherein the cap defines an opening configured to receive and engage at least a portion of the body portion in the closed position.

18. The fastener assembly of claim 17, wherein the fastener comprises a pair of flexible legs resiliently coupled to the base portion.

19. The fastener assembly of claim 18, wherein each of the pair of flexible legs comprises one or more rigid retention features at an outer surface thereof.

20. The fastener assembly of claim 17, wherein the retainer and the cap are an integrated component.
